(19) United States
(12) Patent Application Publication
(10) Pub. No.: US 2009/0217769 A1
(43) Pub. Date: Sep. 3, 2009

(54) STRUCTURAL MONITORING

(75) Inventor: Richard Damon Goodman Roberts, Southampton (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Insensys Limited

(21) Appl. No.: 12/281,426

(22) PCT Filed: Feb. 17, 2007
(86) PCT No.: PCT/GB07/00543

§ 371 Date: Jan. 19, 2009

(30) Foreign Application Priority Data
Mar. 2, 2006 (DE) 0604230.3

(51) Int. Cl. G01L 1/24; G01N 3/00

(52) U.S. Cl. 73/800

(57) ABSTRACT

Apparatus (10) for monitoring changes in the shape of a hollow structure (20) comprises a flexible elongate support (12), which includes several optical fibre strain sensors (14, 16, 18) each arranged to measure strain in the longitudinal direction of the support (12). The strain sensors (14, 16, 18) are spaced in a direction perpendicular to the longitudinal direction of the support and the support is adapted to bear against the inner surface of the hollow structure (20), such that changes in shape of the structure along the longitudinal direction result in generally corresponding changes in shape of the support.

### FIELD OF THE INVENTION

The invention relates to an apparatus and method for monitoring changes in the shape of a structure.

### BACKGROUND TO THE INVENTION

There is interest in monitoring the shape and bend radius of structural members for a number of reasons. For example, monitoring the bend radius of a pipe can identify when the radius of the pipe approaches critical levels. Fatigue information can also be obtained by measuring the change in bend radius or shape, and fatigue analysis can help determine the remaining lifetime of the structure.

### SUMMARY OF THE INVENTION

According to one aspect of this invention, there is provided apparatus for monitoring changes in the shape of a hollow structure, the apparatus comprising a flexible elongate support having a longitudinal direction and including a plurality of strain sensors each arranged to measure strain in the longitudinal direction of the support, wherein the strain sensors are spaced in a direction perpendicular to the longitudinal direction of the support and the support is adapted to bear against the inner surface of a hollow structure, in use, such that changes in shape of the structure along the longitudinal direction result in generally corresponding changes in shape of the support.

According to a further aspect of this invention, there is provided a method for monitoring changes in the shape of a hollow structure, the method comprising:

providing a flexible elongate support having a longitudinal direction and including a plurality of strain sensors each arranged to measure strain in the longitudinal direction of the support, wherein the strain sensors are spaced in a direction perpendicular to the longitudinal direction of the support; and

locating the support within the hollow structure such that the support bears against an inner surface of a hollow structure so that changes in shape of the structure along the longitudinal direction result in generally corresponding changes in shape of the support.

In a simple arrangement, the hollow structure may comprise a tube, pipe or other similar structure into which the support is inserted. The structure may have a variety of cross-sectional shapes, including circular, elliptical, square, rectangular, triangular, polygonal, etc. In one embodiment, the support is dimensioned so that its external dimensions correspond generally to the internal dimensions of the hollow structure, whereby the support fills substantially the entire interior space of the structure.

However, where the support fills substantially the entire interior space of the structure, it may be difficult to insert the support into the structure because of friction between the exterior of the support and the interior of the structure. Consequently, adhesive or filler may be provided to occupy any space between the support and the interior surface of the structure. Of course, it is not necessary for the support to fill the entire interior space of the structure and the support may be bonded to the interior surface of the structure, for example continuously along its length or at intervals.

In one arrangement, the support is urged towards the inner surface of the structure by a clamping member. The clamping member may bear against a further inner surface of the structure to urge the support towards the inner surface of the structure. The clamping member may be located between two or more supports, urging each towards respective inner surfaces of the structure. The clamping member may include a resilient component, such as a compression spring, to urge the support(s) towards the inner surface of the structure. Alternatively or in addition, the clamping member may include a mechanical component, such as a screw thread or wedge, to urge the support(s) towards the inner surface of the structure. A plurality of clamping members may be provided at intervals along the length of the support(s).

In one advantageous arrangement, the clamping member comprises a camming surface. The camming surface may engage with a corresponding camming surface on an adjustment member, whereby axial movement of the adjustment member may produce radial movement of the clamping member.

The clamping member may include a deformable member, such as a rubber or elastomer ring, which is squeezed in an axial direction to achieve a radial clamping force.

The support may be clamped to the inner surface of the structure, such that the support follows the general shape of the structure, but can move in the longitudinal direction relative to the structure. In this way, there is “slippage” between the support and the structure, whereby the strain sensors do not measure axial strains on the structure, but only changes in shape. Of course, if it is desired to measure axial strain, the support may clamped sufficiently tightly that there is no slippage.

In a preferred embodiment, the strain sensors are optical fibre strain sensors. Thus, the support comprises a plurality of longitudinal optical fibres. The optical fibres may be mounted to the surface of the support or embedded in the support, for example. The optical fibre strain sensors may be fibre Bragg grating sensors. Alternatively, the optical fibre strain sensors may use alternative sensor techniques, such as Rayleigh scattering.

The support may comprise a plurality of strain sensors spaced in the longitudinal direction. For example, each optical fibre may comprise a plurality of strain sensors. The optical fibres may be arranged at a non-zero angle to the longitudinal direction of the support.

In certain embodiments, the invention provides a structural member bend radius sensor apparatus comprising a plurality of optical fibre strain sensors, and sensor carrier apparatus (the support), the optical fibre strain sensors being mechanically coupled thereto at a plurality of measurement locations. The sensor carrier apparatus can be mechanically coupled to an internal surface of a structural member to be measured such that the strain sensors are located at different angular positions around the internal circumference of the structural member and/or at different distances from the neutral axis of the structural member.

The sensor carrier apparatus may comprise a carrier rod. The strain sensors are preferably mechanically coupled to the carrier rod at a plurality of measurement locations spaced around the surface of the carrier rod. The strain sensors may be mechanically coupled to the carrier rod at two generally opposed measurement locations. The strain sensors may alternatively be mechanically coupled to the carrier rod at three or more measurement locations substantially evenly spaced around the surface of the carrier rod.

The carrier rod is preferably formed with a generally longitudinally extending groove at a measurement location, and the respective optical fibre strain sensor is at least partially received in the groove. The optical fibre strain sensor is preferably secured in the groove by means of an adhesive. One or more optical fibre strain sensors may alternatively be fixed to the surface of the carrier rod at their respective measurement locations, preferably by means of adhesive. One or more optical fibre strain sensors may further alternatively be embedded within the carrier rod at their respective measurement locations.

The strain sensors may be provided within a single optical fibre or may be provided within a plurality of optical fibres corresponding to the number of measurement locations.

The sensor carrier apparatus may alternatively comprise a plurality of carrier rods to be mechanically coupled to the structural member at a corresponding plurality of locations spaced around the circumference of the structural member. Preferably, two carrier rods are to be mechanically coupled to the structural member at two generally opposed locations within the structural member. Alternatively, three or more carrier rods may be mechanically coupled to the structural member at a corresponding three or more locations substantially equally spaced around the circumference of the structural member.

Preferably, at least one optical fibre strain sensor is provided on each carrier rod. The optical fibre strain sensors are preferably embedded within their respective carrier rods. The optical fibre strain sensors may alternatively be fixed to the surface of their respective carrier rods. The optical fibre strain sensors preferably extend generally longitudinally along their respective carrier rod.

The strain sensors may be provided within a single optical fibre or may be provided within a plurality of optical fibres corresponding to the number of carrier rods.

The or each carrier rod is preferably to be located on the structural member such that it extends generally longitudinally along the structural member. The or each carrier rod may alternatively to be wound within the structural member, and is preferably to be generally helically wound within the structural member. The or each carrier rod may be a rod of a composite material, a plastics material, or a resin material

The sensor carrier apparatus preferably additionally comprises coupling apparatus for coupling the or each carrier rod to a structural member. The coupling apparatus preferably comprises mechanical fixing means, such as mechanical clamp apparatus, for example a plurality of mechanical clamps.

The sensor carrier apparatus may further alternatively comprise a shaped carrier member. The shaped carrier member is preferably at least part-cylindrical in shape. The shaped carrier member is preferably part-circular in cross-section, and may be less than semi-circular in cross-section. The sensor carrier apparatus may alternatively comprise two substantially hemi-cylindrical shaped carrier members.

The sensor carrier apparatus preferably additionally comprises coupling apparatus for coupling the or each shaped carrier member to a structural member. The coupling apparatus preferably comprises mechanical fixing means, such as mechanical clamp apparatus, for example a plurality of mechanical clamps.

The or each shaped carrier member is preferably flexible compared to the structural member to which it is to be coupled. The or each shaped carrier member may be constructed from a composite material, such as glass fibre or carbon fibre in an epoxy resin or a polyester resin, or may be constructed from a plastics material.

The or each shaped carrier member preferably has a complimentary external radius to the internal radius of the structural member to which it is to be coupled, such that the or each shaped carrier member will closely fit within the structural member.

The strain sensors are preferably provided on the or each shaped carrier member at a plurality of locations spaced across the or each shaped carrier member.

The strain sensors are preferably embedded within the or each shaped carrier member. The strain sensors may alternatively be provided on a surface of the or each shaped carrier member.

One or more of the optical fibre strain sensors preferably comprises a fibre grating strain sensor. The fibre grating strain sensor may be a fibre Bragg grating or may be a fibre Bragg grating Fabry-Perot etalon. One or more of the optical fibre strain sensors may alternatively comprise an optical fibre Fabry-Perot etalon. Each grating or etalon may have substantially the same resonant wavelength or may have a different resonant wavelength.

The structural member bend radius sensor apparatus may further comprise a duplicate set of optical fibre strain sensors provided generally alongside the optical fibre strain sensors to provide for sensor redundancy within the apparatus.

A plurality of structural member bend radius sensor apparatus may be provide with each bend radius sensor apparatus located at a different position along a structural member.

Where the sensor carrier apparatus comprises a carrier rod, a single carrier rod may be used to carry the optical fibre strain sensors for each of the plurality of bend radius sensor apparatus.

Where the sensor carrier apparatus comprises two carrier rods, a single set of two carrier rods be used to carry the optical fibre strain sensors for each of the plurality of bend radius sensor apparatus.

Where the sensor carrier apparatus comprises three or more carrier rods, a single set of three or more carrier rods be used to carry the optical fibre strain sensors for each of the plurality of bend radius sensor apparatus.

Where the sensor carrier apparatus comprises one or more shaped carrier members, a single shaped carrier member or a single set of shaped carrier members may be used to carry the optical fibre strain sensors for each of the plurality of bend radius sensor apparatus.

The apparatus may comprise optical fibre strain sensor interrogation apparatus to which the optical fibre strain sensors are optically coupled, the interrogation apparatus being operable to optically interrogate the optical fibre strain sensors.

The interrogation apparatus is preferably further operable to convert measured strains into a bend radius. The interrogation apparatus is preferably further operable to convert measured strains into bend radii, and to convert the bend radii into the shape of the structural member. The interrogation apparatus may be further operable to convert the bend radii into the shape of the structural member and, from the shape of the structural member, to calculate the strain present across a joint.

The joint may be a straight joint between two structural members, the shape sensor apparatus being provided within either structural member forming the joint. The joint may alternatively be a T-joint between three structural members, the shape sensor apparatus preferably being provided within the generally perpendicular structural member.

The interrogation apparatus may be located locally to the joint, and may be attached to the sensor carrier apparatus.

The or each structural member may comprise a section of pipeline. The pipeline may be a sub-sea pipeline, and may be a sub-sea oil pipeline or gas pipeline.

### BRIEF DESCRIPTION OF THE DRAWINGS

Embodiments of the invention will now be described in detail, by way of example only, with reference to the accompanying drawings, in which:

FIG. 1 is a diagrammatic cross-sectional representation of apparatus according to a first embodiment of the invention, shown in use within a structural member;

FIG. 2 is a diagrammatic cross-sectional representation of sensor apparatus according to a second embodiment of the invention;

FIG. 3 is a diagrammatic representation of measurement apparatus, incorporating the bend sensor apparatus of FIG. 2, according to a third embodiment of the invention;

FIG. 4 is a diagrammatic cross-sectional representation of sensor apparatus according to a fourth embodiment of the invention, shown in use within a structural member;

FIG. 5 is a diagrammatic cross-sectional representation of sensor apparatus shown in use on a structural member;

FIG. 6 is a diagrammatic representation of sensor apparatus, shown in use on a structural member;

FIG. 7 is a diagrammatic cross-sectional representation of sensor apparatus according to a fifth embodiment of the invention, shown in use within a structural member;

FIG. 8 is a diagrammatic representation of measurement apparatus;

FIG. 9 is a diagrammatic representation of structural member joint monitoring apparatus;

FIG. 10 is a diagrammatic end view in direction A-A of FIG. 9;

FIG. 11 is a diagrammatic cross-sectional view of sensor apparatus according to a sixth embodiment of the invention;

FIG. 12 is a perspective view of a sensor apparatus according to seventh embodiment of the invention;

FIG. 13 is a schematic end view of the sensor apparatus of FIG. 12; and

FIG. 14 is a schematic plan view, partially in section, of the sensor apparatus of FIGS. 12 and 13.

### DETAILED DESCRIPTION OF EMBODIMENTS

In the following, some example sensor devices are shown which are not embodiments of the invention because they are mounted to the outside of a structural member. However, given the teaching of this application, the skilled person will appreciate how the features of such devices can be used in embodiments of the invention.

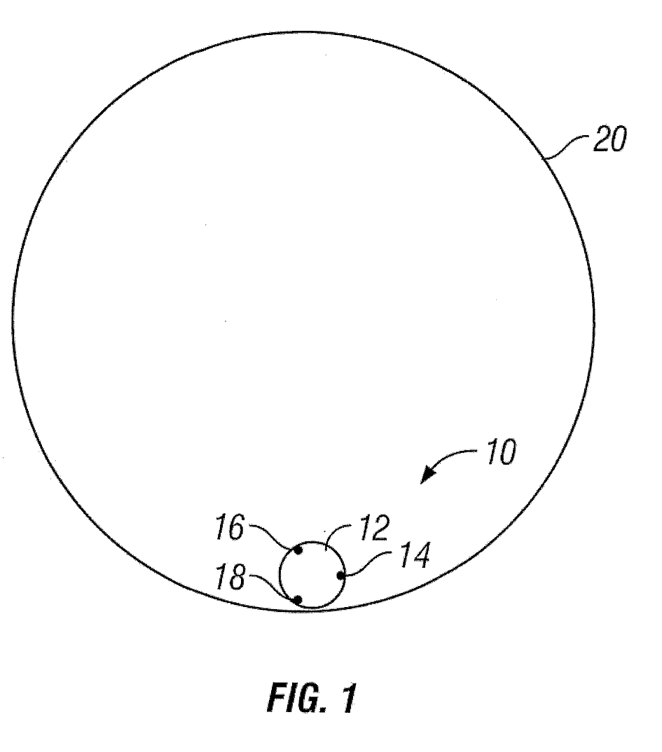

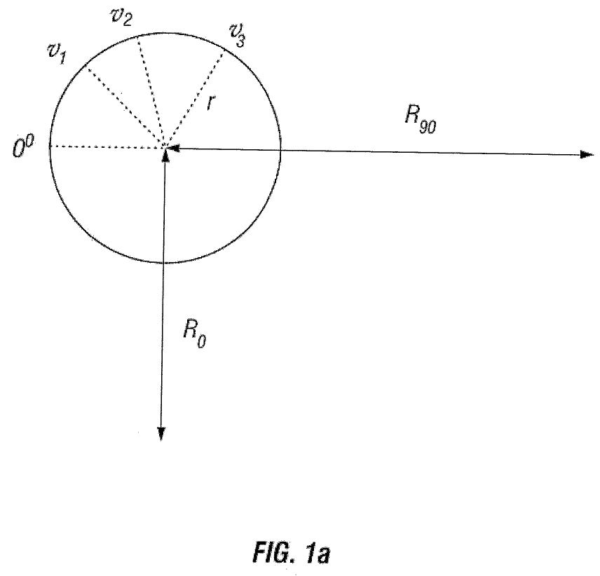

Referring to FIG. 1, a first embodiment of the invention provides structural member bend radius sensor apparatus 10. The apparatus 10 comprises three optical fibre strain sensors (not shown in FIG. 1), which in this example take the form of fibre Bragg gratings (FBGs), each having a resonant wavelength of 1550 nm and a spectral linewidth of 0.07 nm, and sensor carrier apparatus in the form of a carrier rod 12, having a circular cross-section. The carrier rod 12 is a rod of epoxy resin, having a diameter of ˜5 mm.

The FBG strain sensors are respectively provided in three optical fibres 14, 16, 18. The optical fibres 14, 16, 18 are embedded within the carrier rod 12, such that the fibres 14, 16, 18, and thus the FBGs, extend generally longitudinally along the carrier rod 12. The fibres 14, 16, 18 are embedded close to the surface of the carrier rod 12 and are substantially equally spaced from one another around the carrier rod 12.

The FBG strain sensors are thereby mechanically coupled to the carrier rod 12 at three measurement locations located generally within a single cross-sectional plane of the carrier rod 12, and are equally spaced around the surface of the carrier rod 12.

In use, the carrier rod 12 is mechanically coupled, for example by means of a plurality of mechanical clamps or adhesive, to the inner surface of a hollow structural member 20 the radius of which is to be measured or monitored. In this example the structural member takes the form of a pipe 20.

Due to the spaced locations of the fibres 14, 16, 18 around the surface of the carrier rod 12, the FBG strain sensors are located at different angular positions around the circumference of the pipe 20, and at different distances from the central (neutral) axis of the pipe 20.

A single strain sensor located at a single measurement location offset from the neutral axis of a structural member can be used to measure the bend radius of the structural member. However, structural members, such as pipes, are often simultaneously exposed to axial strain and strain due to bending, and a single strain sensor can not discriminate between these two strain sources.

By using two or more strain sensors provided at spaced measurement locations around the circumference of the structural member, it is possible to discriminate between axial strain and bending in different directions. For example, axial strain can be determined from the average of two strain sensors arranged generally opposite each other. Bending can be determined from the difference in strain measured by the two sensors and the distance between the strain sensors.

Using three strain sensors provided at three measurement locations around the circumference of the structural member enables bending information in two dimensions to be obtained, provided that the three strain sensors are not all located within a single longitudinal plane through the structural member.

The strain sensors should preferably be located within a single cross-sectional plane through the structural member, in order to measure bending within that plane. However, it will be appreciated that structural members such as pipes can have a large diameter and a long length, meaning that the strain conditions change extremely slowly along the pipe. As a result, the strain sensors within a single bend radius sensor do not actually have to lie within a single cross-sectional plane through the pipe, but can in fact be offset from that plane without causing any noticeable deterioration in the accuracy of the bend radius and/or axial strain measurements.

For a point offset by a distance dr from the neutral axis of a structural member, the strain is given by

ε=dr/R

where R is the local radius of curvature of the structural member. If the distance of a strain sensor from the neutral axis is known, then the strain measurement can be converted to a local radius of curvature. For example, for a 0.25 m radius pipe with a strain sensor on the inside measuring 1000 με (0.001) the local radius of curvature is 250 m.

For a 10 mm diameter rod containing four fibres located on the inner surface of the same pipe, the difference in strain values will be

dR/R=0.01/250=0.00004 or 40 microstrain

This difference in strain can be used to measure the local bend radius of the pipe. If both sensors increase or decrease together (common mode response) this can be used to measure the axial strain in the pipe.

Where bending occurs in two dimensions and three or more strain sensors are used, as illustrated in FIG. 1(a), the bend radius of the pipe 20 in orthogonal directions R₉₀ and R₀ can be determined using the following equations:

$${R}_{90} = \frac{\begin{matrix}[ cos ( {υ}_{3} ) - cos ( {υ}_{2} ) ] / [ sin ( {υ}_{3} ) - sin ( {υ}_{2} ) ] - \\ [ cos ( {υ}_{2} ) - cos ( {υ}_{1} ) ] / [ sin ( {υ}_{2} ) - sin ( {υ}_{1} ) ]\end{matrix}}{\begin{matrix}[ {ɛ}_{3} - {ɛ}_{2} ] / r [ sin ( {υ}_{3} ) - sin ( {υ}_{2} ) ] - \\ [ {ɛ}_{2} - {ɛ}_{1} ] / r [ sin ( {υ}_{2} ) - sin ( {υ}_{1} ) ]\end{matrix}}$$

$${R}_{0} = \frac{r [ sin ( {υ}_{2} ) - sin ( {υ}_{1} ) ]}{[ {ɛ}_{2} - {ɛ}_{1} ] - r [ cos ( {υ}_{2} ) - cos ( {υ}_{1} ) ] / {R}_{90}}$$

where υ₁ is the angular position of the first FBG strain sensor, υ₂ is the angular position of the second FBG strain sensor, υ₃ is the angular position of the third FBG strain sensor, r is the radius of the pipe, ε₁ is the strain measured by the first FBG strain sensor, ε₂ is the strain measured by the second FBG strain sensor and ε₃ is the strain measured by the third FBG strain sensor.

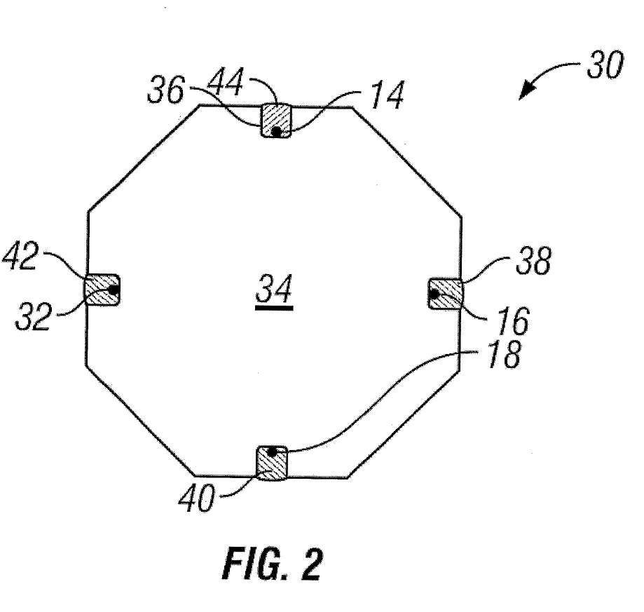

FIG. 2 shows structural member bend radius sensor apparatus 30 according to a second embodiment of the invention. The bend radius sensor apparatus 30 of this embodiment is substantially the same as the apparatus 10 of the first embodiment, with the following modifications. The same reference numbers are retained for corresponding features.

In this embodiment four FBG strain sensors are respectively provided within four optical fibres 14, 16, 18, 32. The carrier rod 34 has an octagonal cross-section in this example.

The fibres 14, 16, 18, 32 are respectively located within four longitudinally extending channels 36, 38, 40, 42 provided on two opposing sets of the eight faces of the carrier rod 34. The fibres 14, 16, 18, 32 are fixed within the channels 36, 38, 40, 42 by means of adhesive 44, thereby mechanically coupling the fibres 14, 16, 18, 32, and thus the FBG strain sensors, to the carrier rod 34.

The addition of a fourth FBG strain sensor around the surface of the carrier rod 34 improves the accuracy of the bend radius measurements made using the apparatus 30, and provides for redundancy should one of the fibres 14, 16, 18, 32 fail.

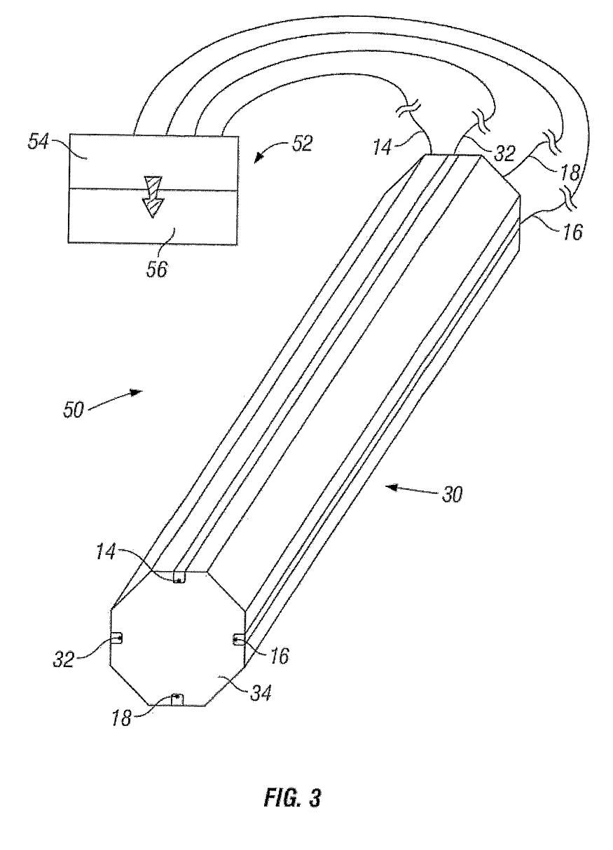

Bend radius measurement apparatus 50 according to a third embodiment of the invention is shown in FIG. 3. The bend radius measurement apparatus 50 comprises bend radius sensor apparatus 30 as shown in FIG. 2 and optical fibre strain sensor interrogation apparatus 52. The optical fibre strain sensor interrogation apparatus 52 comprises FBG interrogation apparatus 54, operable to optically interrogate the FBG strain sensors, and processor means 56.

The optical fibres 14, 16, 18, 32, and thus the FBG strain sensors, are optically coupled to the FBG interrogation apparatus 54. Suitable FBG interrogation apparatus will be well known to the person skilled in the art, and will not be described in detail here. One particularly suitable FBG interrogation apparatus is described in International patent application number WO 2004/056017.

The wavelength information measured by the FBG interrogation apparatus 54 is passed to the processor means 56, which is operable to convert the wavelength information into the axial strain and bend induced strain experience by the FBG strain sensors, and thus into the radius of a structural member (not shown) to which the carrier rod 34 is mechanically coupled.

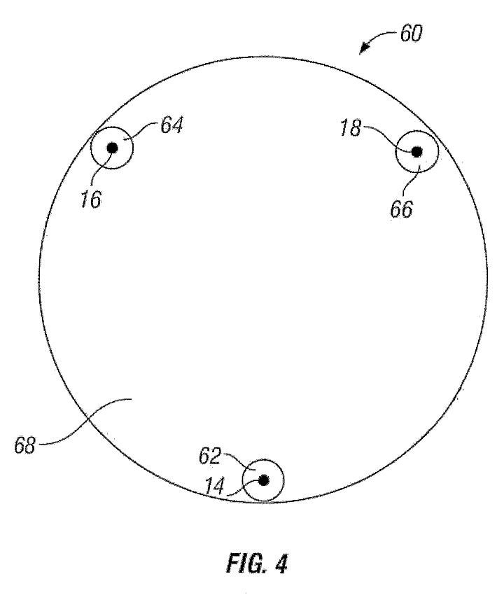

Structural member bend radius sensor apparatus 60 according to a fourth embodiment of the invention is shown in FIG. 4. The apparatus 60 of this embodiment is substantially the same as the apparatus of FIG. 1, with the following modifications. The same reference numerals are retained for corresponding features.

In this embodiment the sensor carrier apparatus takes the form of three carrier rods 62, 64, 66, each of generally circular cross-section. The three optical fibres 14, 16, 18 are respectively embedded within the three carrier rods 62, 64, 66 and extend generally axially through their respective carrier rods 62, 64, 66.

In use, the carrier rods 62, 64, 66 are mechanically coupled, for example by means of mechanical clamps, within a structural member the radius of which is to be measured or monitored. In this example the structural member takes the form of a pipe 68.

The carrier rods 62, 64, 66 are to be substantially equally spaced around the circumference of the pipe 68, so that the FBG strain sensors are provided at three measurement locations, at three angular positions around the pipe 68.

Another structural member bend radius sensor apparatus 70 is shown in FIG. 5. This apparatus is not an embodiment of the invention and is shown to illustrate the position of four optical fibres relative to a support member.

In this arrangement, a fourth FBG strain sensor is additionally provided, within a fourth optical fibre. The fourth fibre is embedded within a fourth carrier rod 72, and extends generally axially through the rod 72.

In this example, the bend radius sensor apparatus 70 is to be used with a pipe 74, which is provided with an outer cladding coating 76. The carrier rods 62, 64, 66, 72 are substantially evenly spaced around the circumference of the cladding 76, in two sets of generally opposed pairs 62, 66 and 64, 72. The carrier rods 62, 64, 66, 72 are fixed in place, and mechanically coupled to the riser pipe 74, by means of pipe wrapping 78, in the form of carbon fibres helically wound around the cladding 76 and carrier rods 62, 64, 66, 72.

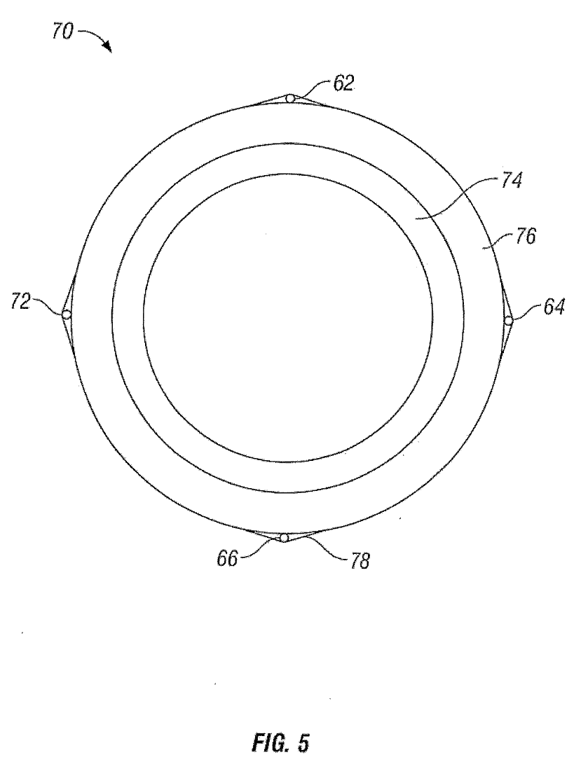

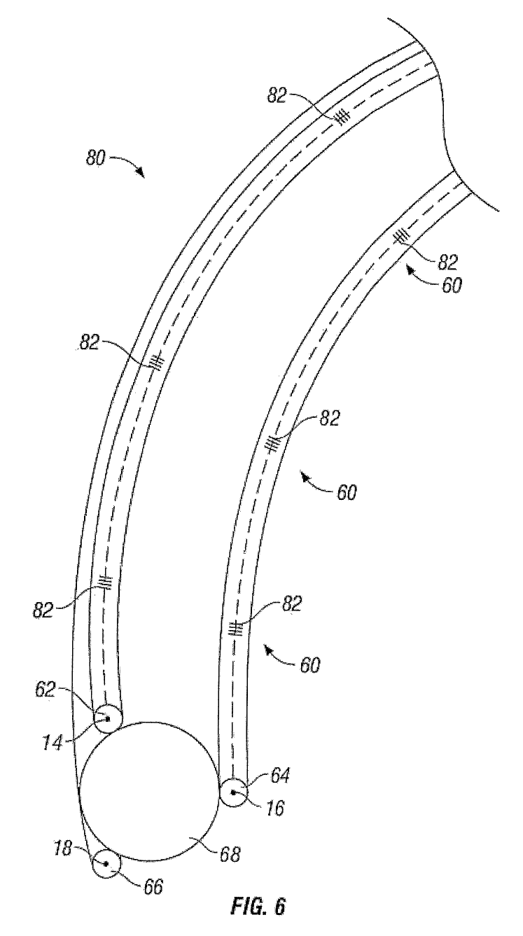

FIG. 6 shows another structural member shape sensor apparatus 80, which is not an embodiment of the invention. The shape sensor apparatus 80 comprises a plurality of bend radius sensor apparatus 60 (only three are shown for clarity). The three bend radius sensor apparatus 60 are spaced apart from one another, at three bend radius measurement positions along the pipe 68. The three bend radius sensor apparatus 60 shown share their optical fibres 14, 16, 18 and their carrier rods 62, 64, 66, rather than each bend radius sensor apparatus 60 having its own separate fibres and carrier rods, thus simplifying the structure of the shape sensor apparatus 80.

In the section of the shape sensor apparatus 80 shown, each carrier rod 62, 64, 66 therefore has three FBG strain sensors 82 provided within it, at three axially spaced bend radius measurement positions.

In use, the bend radii determined by the three bend radius sensor apparatus 60 are used to determine the shape of the pipe 68 to which the shape sensor apparatus 80 is coupled. The bend radii can also be used to determine the fatigue lifetime of the pipe 68.

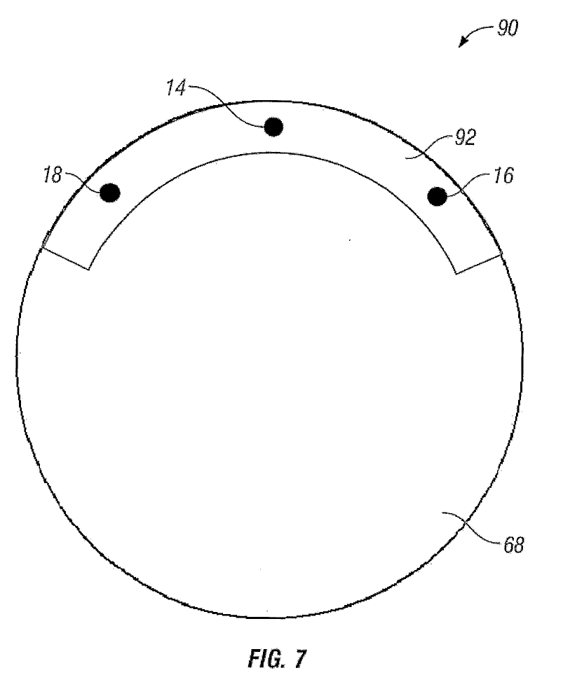

A fifth embodiment of the invention, shown in FIG. 7, provides bend radius sensor apparatus 90 which is substantially the same as the bend radius sensor apparatus 60 of the fourth embodiment, with the following modifications. The same reference numbers are retained for corresponding features.

In this embodiment, the sensor carrier apparatus takes the form of a shaped carrier member 92. The shaped carrier member 92 comprises a moulded sheet of glass fibre/epoxy resin composite material, having a thickness of 8 mm, which is flexible relative to the pipe 68. The shaped carrier member 92 is part cylindrical in shape, being part-circular in cross-section and extending for less than 180 degrees of a circle. The external radius of curvature of the shaped carrier member 92 matches the internal radius of curvature of the pipe 68 to which the shaped carrier member 92 is to be coupled in use, as shown in FIG. 7. This is so that a close mechanical coupling may be achieved between the shaped carrier member 92 and the pipe 68.

In this embodiment, the optical fibres 14, 16, 18 containing the FBG strain sensors are embedded within the shaped carrier member 92. The fibres 14, 16, 18 are arranged to extend generally longitudinally through the shaped carrier member 92. The fibres 14, 16, 18 are provided at three spaced locations across the shaped carrier member 92 so that, in use, the three respective FBG strain sensors will be located at three different angular positions around the circumference of the pipe 68.

The shaped carrier member 92 is held in place on the pipe 92 by means of mechanical clamps (not shown in FIG. 7).

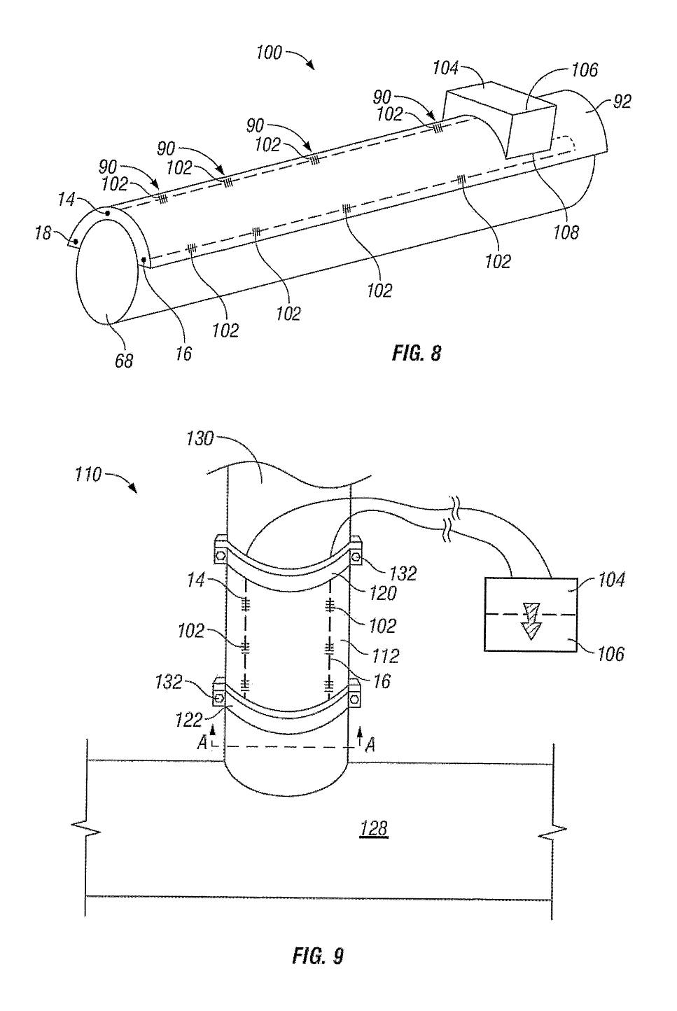

FIG. 8 shows another structural member shape measurement apparatus 100 that is not an embodiment of the invention. The shape measurement apparatus 100 comprises four bend radius sensor apparatus 90 spaced apart from one another, at four bend radius measurement positions along the pipe 68. The four bend radius sensor apparatus 90 shown share their optical fibres 14, 16, 18, with four FBG strain sensors 102 being provided in each fibre. The fibres 14, 16, 18 are embedded within a single shaped carrier member 92, which is part-cylindrical in shape.

The shape sensor apparatus 100 therefore has twelve FBG strain sensors 102 provided within the shaped carrier member 92, provided at twelve axially and angularly different measurement locations.

The apparatus 100 further comprises optical fibre strain sensor interrogation apparatus in the form of FBG interrogation apparatus 104, to which the optical fibres 14, 16, 18, and thus the FBGs 102, are optically coupled. The interrogation apparatus 104 is operable to optically interrogate the FBG strain sensors 102. Suitable FBG interrogation apparatus will be well known to the person skilled in the art, and will not be described in detail here. One particularly suitable FBG interrogation apparatus is described in International patent application number WO 2004/056017.

The optical fibre strain sensor interrogation apparatus further comprises processor means 106, in communication with the FBG interrogation apparatus 104, operable to convert measured wavelengths into strains, strains into bend radii, and bend radii into the shape of the pipe 68. The processor means 106 is also operable to determine the fatigue lifetime of the pipe 68 from the bend radii.

In this embodiment, the FBG interrogation apparatus 104 is provided within a housing unit 108, mounted on the shaped carrier member 92. The FBG interrogation apparatus 104 may alternatively be located remote from the pipe 68 and the shaped carrier member 92.

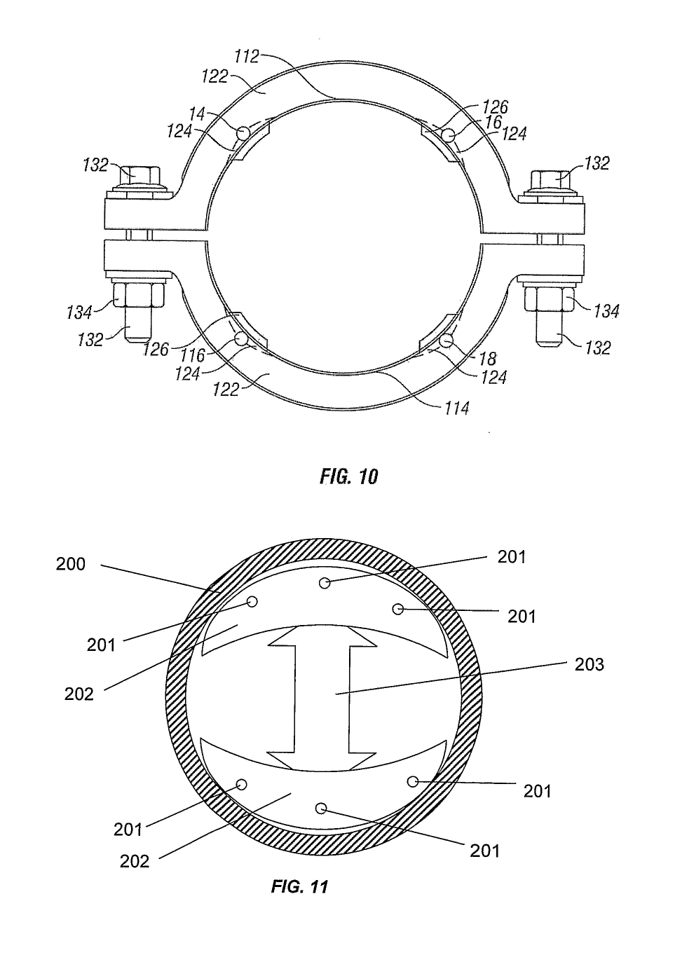

FIGS. 9 and 10 show structural member joint monitoring apparatus 110 that is not an embodiment of the invention.

In this arrangement, the sensor carrier apparatus takes the form of two approximately hemi-cylindrical shaped carrier members 112, 114, formed from E-glass, and two 2-part mechanical clamps 120, 122, fabricated from carbon fibre composite material. In use, the two shaped carrier members 112, 114 are mechanically coupled to the pipe 130 by means of the clamps 120, 122 fixed around each end of the shaped carrier members 112, 114. The two parts of the clamps 120, 122 are held together by bolts 132, located through apertures formed in clamps 120, 122, and nuts 134.

Two optical fibres 14, 16 are provided on the first shaped carrier member 112 and two optical fibres 18, 116 are provided on the second shaped carrier member 114. The fibres 14, 16, 18, 116 are fixed onto the surface of the respective shaped carrier members 112, 114 by means of adhesive. The fibres 14, 16, 18, 116 extend generally longitudinally along the surfaces of their respective shaped carrier members 112, 114. Each optical fibre is provided with three FBG strain sensors 102, which are located at three axially spaced measurement locations, thereby forming three sets of bend radius sensor apparatus. The clamps 120, 122 have recesses 124 formed in their internal surfaces, in which the fibres 14, 16, 18, 116 are received, in order to prevent the fibres being damaged by the clamps 120, 122.

A carbon fibre contact pad 126 is provided on the internal surface of each shaped carrier member 112, 114 at each end, in the area where the clamps 120, 122 are located, and underneath each fibre 14, 16, 18, 116. The contact pads 126 define the mechanical contact points between the shaped carrier members 112, 114 and the pipeline 130.

In this example, the FBG interrogation apparatus 104 and the processor means 106 are located remotely from the joint being monitored.

The structural member joint monitoring apparatus 110 is for use in monitoring the strain present across a joint between two, or more, structural members, such as a joint between a main (trunk) pipe 128 and a bypass (branch) pipe 130. By monitoring the shape of one pipe forming a joint, the strain conditions present within the joint may be determined. The processor means 106 of this example is additionally operable to determine the strain conditions within the joint from the shape measurement made of the branch pipe 130. This information may be used to determine the fatigue lifetime of the joint.

FIG. 11 shows an apparatus for monitoring the shape of a structure according to a sixth embodiment of the invention. In this case, the structure is a pipe 200. The apparatus comprises six optical fibre strain sensors 201, embedded in two flexible supports 202, with three optical fibres embedded in each support. The supports 202 are urged into intimate contact with the inside surface of the pipe 200 by an expanding clamp 203 incorporating a compression spring. A plurality of expanding clamps can be provided at intervals along the longitudinal direction (into the page in FIG. 1) of the supports 202 so that the supports and fibres adopt the general shape of the pipe 200.

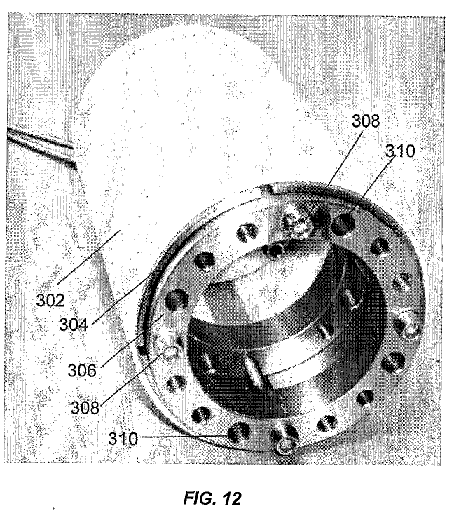

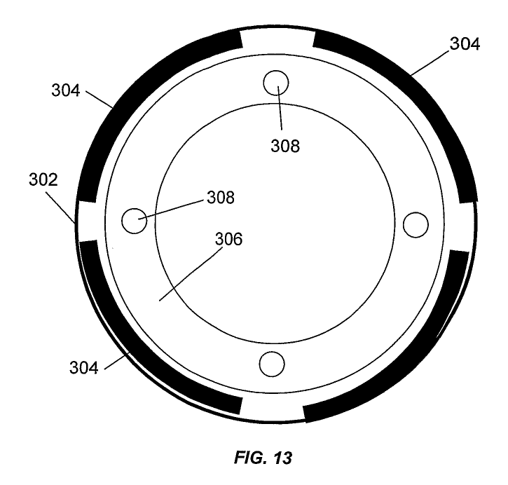

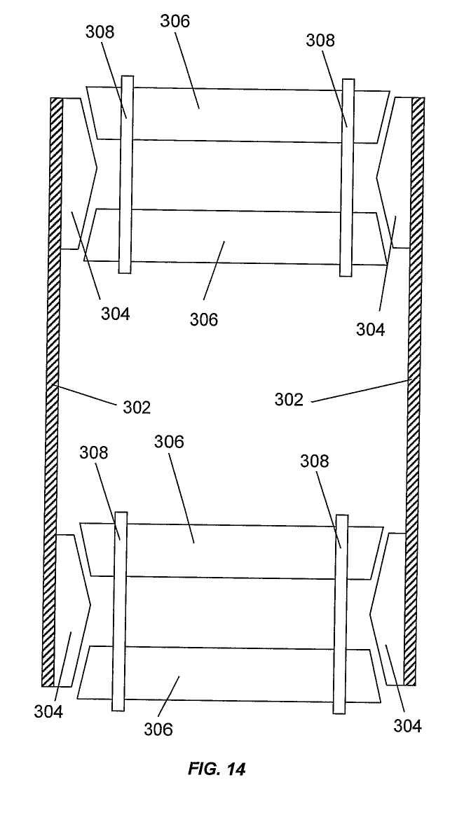

FIGS. 12 to 14 show a sensor apparatus according to a seventh embodiment of the invention. The apparatus for monitoring the shape of a structure according to the seventh embodiment of the invention is particularly suited to monitoring the interior of cylindrical structures, such as pipe, or the like (not shown). In this embodiment, the optical fibre strain sensors are embedded in a substantially cylindrical flexible support 302, which forms the outer surface of the sensor apparatus. The flexible support 302 is formed from a sheet of suitable polymer material, into which the appropriate optical fibre strain sensors have been embedded. The sheet material is rolled into a tube having a diameter only slightly smaller than the diameter of the structure to be monitored. In this way, the flexible support (and thus the strain sensors) are located over substantially a full 360 degrees of the interior surface of the structure. The material of the flexible support 302 is selected to be compliant relative to the structure to be monitored but have sufficient stiffness to avoid buckling in normal use.

Mounted to the interior of the flexible support are a plurality of clamping members 304. In the example shown, four clamping members 304 are bonded to each end portion of the cylindrical flexible support 302, with each clamping member 304 occupying substantially one quarter of the inner circumferential surface of the cylindrical flexible support 302. In this way, the clamping members 304 are evenly distributed about substantially the entire circumference of the flexible support 302 in order to provide an even radial clamping force against the structure to be monitored. In the embodiment show, the clamping members occupy approximately 85 degrees each, which allows spacing between them for expansion.

At each end of the cylindrical flexible support 302, the four clamping members engage a pair of parallel clamping rings 306, which are urged towards each other by four adjustment bolts 308, which pass through bolt holes in the clamping rings 306. Each of the clamping rings 306 has a periphery which decreases in diameter in the axial direction towards the other clamping ring 306. Each clamping member 304 is formed with a inner camming surface that is complimentary to the peripheral surface of clamping rings 306. Thus the clamping members 304 have a substantially triangular cross-section viewed in the circumferential direction. The camming surface of each clamping member 304 engages the peripheral surfaces both clamping rings 306, such that clamping members 304 are urged radially outwardly as the clamping rings 306 are urged towards each other by the adjustment bolts 308. In this way, when the adjustment bolts 308 are tightened, the flexible support 302 is urged against the inner surface of the structure to be monitored and clamped securely against that inner surface. In this way, movements of the structure cause corresponding movements of the flexible support, which can be measured by the strain sensors.

The clamping rings 306 are provided with additional adjustment holes 310, through which a tool can be inserted to tighten the adjustment bolts of the clamping rings 306 at the other end of the apparatus. In this way, all of the adjustment bolts 310 can be tightened from one end of the apparatus.

The clamping rings 306 are provided at each end of the apparatus in order that the clamping operation itself does not axially strain the flexible support member 302 between the clamping rings 306. However, where the apparatus is to monitor a substantial axial length of a particular structure, for example, additional clamping rings 306 may be provided at intermediate locations between the ends. The use of clamping rings, rather than discs for example, provides a central void within the apparatus in which cables or electronics may be located conveniently.

The angle of the camming surfaces to the axial direction of the clamping rings 306 is selected to provide the maximum clamping force against the inner surface of the structure to be monitored for a given coefficient of friction between the surfaces. Bearings may be used to reduce friction.

In this embodiment, the fibre optic strain sensors may be arranged in the flexible support at an oblique angle, for example 45 degrees, to the axial direction of the clamping rings 306. In this way, torsional strain measurements may be made.

Various modifications may be made to the described embodiments without departing from the scope of the invention. A different number of FBG strain sensors may be used, and they may be provided within a different number of optical fibres to that described. The FBG strain sensors may have a different resonant wavelength and a different line width to those described, and it will be appreciated that the FBG strain sensors do not all have to be of the same resonant wavelength. The FBG strain sensors may be replaced by a different type of optical fibre strain sensor, including fibre Bragg grating Fabry-Perot etalons and optical fibre Fabry-Perot etalons. Where the gratings are described as having substantially the same resonant wavelength they may alternatively have different resonant wavelengths.

The optical fibres may be located at different distances from the neutral axis of the carrier rod or the structural member, and may alternatively or additionally be located at different angular positions around the surface of the carrier apparatus or the structural member.

The sensor carrier apparatus may comprise a carrier rod having a different cross-sectional shape to that described, and it will be appreciated that a carrier rod of any cross-sectional shape may be used. Where more than one carrier rod is used a different number of carrier rods may be used to that described. The shaped carrier member or members may have a different shaped to those described, and a different number of shaped carrier members may be used. The hemi-cylindrical carrier members of the joint monitoring apparatus may be held together and coupled to a structural member using a different type of mechanical clamp, such a clam-shell type hinged clamp.

The carrier rods and the shaped carrier members may be fabricated from different materials to those described, including plastics materials.

In the embodiments described, the monitoring of structures of circular cross-section has been particularly exemplified. However, the apparatus of the invention may be used to monitor the structures having other cross-sections, for example triangular, rectangular, square and polygonal.

1. Apparatus for monitoring changes in the shape of a hollow structure, the apparatus comprising a flexible elongate support having a longitudinal direction and including a plurality of strain sensors each arranged to measure strain in the longitudinal direction of the support, wherein the strain sensors are spaced in a direction perpendicular to the longitudinal direction of the support and the support is adapted to bear against the inner surface of a hollow structure, in use, such that changes in shape of the structure along the longitudinal direction result in generally corresponding changes in shape of the support.

2. A method for monitoring changes in the shape of a hollow structure, the method comprising:
providing a flexible elongate support having a longitudinal direction and including a plurality of strain sensors each arranged to measure strain in the longitudinal direction of the support, wherein the strain sensors are spaced in a direction perpendicular to the 15 longitudinal direction of the support; and
locating the support within the hollow structure such that the support bears against an inner surface of a hollow structure so that changes in shape of the structure along the longitudinal direction result in generally corresponding changes in shape of the support.

3. Apparatus or a method as claimed in claim 1, wherein the support is dimensioned so that its external dimensions correspond generally to the internal dimensions of the hollow structure, whereby the support fills substantially the entire interior space of the structure.

4. Apparatus or a method as claimed in claim 1, wherein the support is bonded to the interior surface of the structure.

5. Apparatus or a method as claimed in claim 1, wherein the support is urged towards the inner surface of the structure by a clamping member.

6. Apparatus or a method as claimed in claim 5, wherein the clamping member bears against a further inner surface of the structure to urge the support towards the inner surface of the structure.

7. Apparatus or a method as claimed in claim 5, wherein the clamping member include a resilient component, such as a compression spring.

8. Apparatus or a method as claimed in any of claims 5, wherein the clamping member comprises a camming arrangement to urge the support towards the inner surface of the structure.

9. Apparatus or a method as claimed in claim 1, wherein the strain sensors are optical fibre strain sensors.
